(19) United States
(12) Patent Application Publication
(10) Pub. No.: US 2026/0063116 A1
(43) Pub. Date: Mar. 5, 2026

(54) CRYOPUMP

(71) Applicant: SUMITOMO HEAVY INDUSTRIES, LTD., Tokyo (JP)

(72) Inventors: Yuma KANEKO, Tokyo (JP); Yuuki MATSUMOTO, Tokyo (JP); Masashi SUZUKI, Tokyo (JP)

(73) Assignee: SUMITOMO HEAVY INDUSTRIES, LTD., Tokyo (JP)

(21) Appl. No.: 19/319,597

(22) Filed: Sep. 4, 2025

(30) Foreign Application Priority Data
Sep. 5, 2024 (JP) 2024-153218

(51) Int. Cl. F04B 39/10; F04B 37/08; F04B 53/06

(52) U.S. Cl. CPC F04B 39/10; F04B 37/08; F04B 53/06

(57) ABSTRACT

A cryopump includes a purge valve that includes a main valve that is closed so that a purge gas is cut off as a fluid is supplied from a fluid source and that is opened so that the purge gas is supplied as the fluid is exhausted, and a pilot valve that switches between a first state in which the fluid is supplied from the fluid source to the main valve and a second state in which the fluid is exhausted from the main valve. The purge valve is configured to restrict exhaustion of the fluid from the main valve when fluid supplied from the fluid source is stopped with the pilot valve being in the first state.

### CROSS-REFERENCE TO RELATED APPLICATIONS

This application claims priority to Japanese Patent Application No. 2024-153218, filed on Sep. 5, 2024, which is incorporated by reference herein in its entirety.

### BACKGROUND

### Technical Field

A certain embodiment of the present invention relates to a cryopump.

### Description of Related Art

A cryopump is a vacuum pump that captures gas molecules through condensation and adsorption at a cryopanel cooled to a cryogenic temperature and that exhausts the gas molecules. Typically, the cryopump may be used in order to realize a clean vacuum environment required for a semiconductor circuit manufacturing process or the like. In a semiconductor manufacturing process, a hazardous gas having various hazardous properties such as explosiveness, corrosiveness, and toxicity may be used. When the temperature of the cryopump is unintentionally increased due to some abnormal state such as a power failure, the hazardous gas accumulated in the cryopump may be revaporized, which results in an increase in concentration of the hazardous gas in the cryopump. In order to solve such an unsafe state, performing a so-called safety purge, in which the hazardous gas is purged from the cryopump by means of a normally-open purge valve that automatically returns to an open state in the case of a power loss, has been proposed.

### SUMMARY

According to an embodiment of the present invention, there is provided a cryopump including a purge valve that includes a main valve that is closed so that a purge gas is cut off as a fluid is supplied from a fluid source and that is opened so that the purge gas is supplied as the fluid is exhausted and a pilot valve that switches between a first state in which the fluid is supplied from the fluid source to the main valve and a second state in which the fluid is exhausted from the main valve. The purge valve is configured to restrict exhaustion of the fluid from the main valve when fluid supplied from the fluid source is stopped with the pilot valve being in the first state.

According to an embodiment of the present invention, there is provided a cryopump including a purge valve that includes a main valve that is closed so that a purge gas is cut off as a fluid is supplied from a fluid source and that is opened so that the purge gas is supplied as the fluid is exhausted, and a pilot valve that switches between a first state in which the fluid is supplied from the fluid source to the main valve and a second state in which the fluid is exhausted from the main valve and a backup power source that is connected to the pilot valve. The pilot valve includes a solenoid valve that returns to the second state from the first state when a supplied voltage decreases to a voltage equal to or lower than a return voltage. The backup power source includes a power storing element and a voltage boosting circuit that generates the supplied voltage to the solenoid valve after boosting an output voltage of the power storing element to be higher than the return voltage of the solenoid valve.

According to an embodiment of the present invention, there is provided a cryopump including a purge valve that includes a main valve that is closed so that a purge gas is cut off as a fluid is supplied from a fluid source and that is opened so that the purge gas is supplied as the fluid is exhausted and a pilot valve that switches between a first state in which the fluid is supplied from the fluid source to the main valve and a second state in which the fluid is exhausted from the main valve and a backup power source that is connected to the pilot valve. The backup power source includes a power storing element and a power storing element monitor that monitors the power storing element by discharging the power storing element.

Any combinations of the above components or replacements of components or expressions of the present invention between methods, devices, systems, or the like are also effective as aspects of the present invention.

### BRIEF DESCRIPTION OF THE DRAWINGS

FIG. 1 is a diagram schematically showing a cryopump system according to an embodiment.

FIG. 2 is a diagram schematically showing the cryopump system according to the embodiment.

FIG. 3 is a diagram schematically showing an exemplary configuration of a purge valve of the cryopump according to the embodiment.

FIG. 4 is a diagram schematically showing an exemplary configuration of the purge valve of the cryopump according to the embodiment.

FIG. 5 is a diagram schematically showing an exemplary configuration of the purge valve of the cryopump according to the embodiment.

FIG. 6 is a diagram schematically showing an exemplary configuration of the purge valve of the cryopump according to the embodiment.

FIG. 7 is a diagram schematically showing a power source system of the purge valve of the cryopump according to the embodiment.

### DETAILED DESCRIPTION

It is desirable to improve the utility of a safety purge function of a cryopump. According to the present invention, it is possible to improve the utility of a safety purge function of a cryopump. Hereinafter, embodiments for carrying out the present invention will be described in detail with reference to the accompanying drawings. In the description and the drawings, the same or equivalent components, members, and processes will be represented by the same reference numerals, and repetitive description will be omitted as appropriate. The scale and the shape of each of parts shown in the drawings are set conveniently to make the description easy to understand, and are not to be interpreted as limiting unless stated otherwise. The embodiment is merely an example and does not limit the scope of the present invention. All features or combinations thereof described in the embodiment are not essential to the invention.

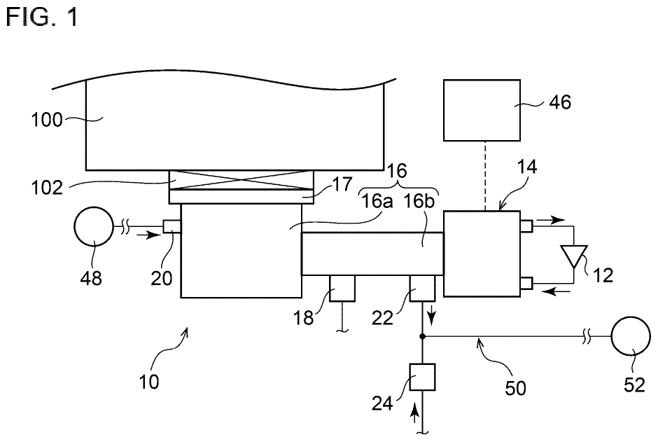

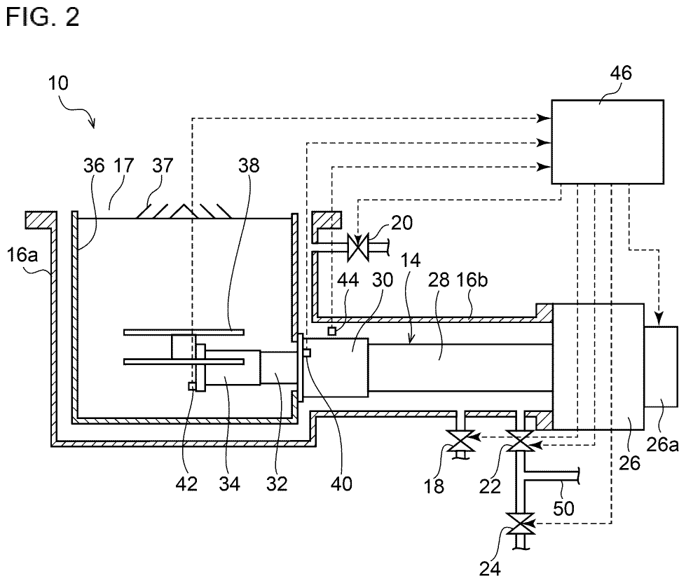

FIGS. 1 and 2 schematically show a cryopump system according to an embodiment. FIG. 1 schematically shows the appearance of a cryopump 10, and FIG. 2 schematically shows the internal structure of the cryopump 10. The cryopump 10 is attached to, for example, a vacuum chamber 100 of an ion implanter, a sputtering device, a deposition device, or other vacuum processing devices, and is used in order to increase a degree of vacuum inside the vacuum chamber 100 to a level required for a desired vacuum process. For example, a high degree of vacuum of approximately 10⁻⁵ Pa to 10⁻⁸ Pa is realized in the vacuum chamber 100.

The cryopump 10 includes a compressor 12, a cryocooler 14, and a cryopump container 16. The cryopump container 16 includes a cryopump intake port 17. In addition, the cryopump 10 includes a rough valve 18, a body purge valve 20, an exhaust valve 22, and an exhaust purge valve 24, and the rough valve 18, the body purge valve 20, the exhaust valve 22, and the exhaust purge valve 24 are installed in the cryopump container 16.

The compressor 12 is configured to collect a refrigerant gas from the cryocooler 14, to pressurize the collected refrigerant gas, and to supply the refrigerant gas to the cryocooler 14 again. The cryocooler 14 is also called an expander or a cold head, and constitutes a cryocooler together with the compressor 12. A thermodynamic cycle, through which chilliness is generated, is formed by circulation of the refrigerant gas between the compressor 12 and the cryocooler 14 with an appropriate combination of pressure fluctuations and volume fluctuations of the refrigerant gas in the cryocooler 14, and thereby the cryocooler 14 can provide cryogenic temperature cooling. Although the refrigerant gas is usually a helium gas, other appropriate gases may also be used. In order to facilitate understanding, a direction in which the refrigerant gas flows is indicated with an arrow in FIG. 1. Although the cryocooler is, for example, a two-stage Gifford-McMahon (GM) cryocooler, the cryocooler may be a pulse tube cryocooler, a Stirling cryocooler, or other types of cryocoolers.

As shown in FIG. 2, the cryocooler 14 includes a room temperature portion 26, a first cylinder 28, a first cooling stage 30, a second cylinder 32, and a second cooling stage 34. The cryocooler 14 is configured to cool the first cooling stage 30 to a first cooling temperature and to cool the second cooling stage 34 to a second cooling temperature. The second cooling temperature is lower than the first cooling temperature. For example, the first cooling stage 30 is cooled to approximately 65 K to 120 K, preferably 80 K to 100 K, and the second cooling stage 34 is cooled to approximately 10 K to 20 K. The first cooling stage 30 and the second cooling stage 34 may also be called a high temperature cooling stage and a low temperature cooling stage, respectively. It is possible to perform an evacuation operation of the cryopump 10 by cooling each of the first cooling stage 30 and the second cooling stage 34 to a target cooling temperature in this manner.

The first cylinder 28 connects the first cooling stage 30 to the room temperature portion 26, and thus, the first cooling stage 30 is structurally supported by the room temperature portion 26. The second cylinder 32 connects the second cooling stage 34 to the first cooling stage 30, and thus, the second cooling stage 34 is structurally supported by the first cooling stage 30. The first cylinder 28 and the second cylinder 32 extend to be coaxial with each other and the room temperature portion 26, the first cylinder 28, the first cooling stage 30, the second cylinder 32, and the second cooling stage 34 are linearly arranged in a line in this order.

In a case where the cryocooler 14 is a two-stage GM cryocooler, a first displacer and a second displacer (not shown) are reciprocally arranged inside the first cylinder 28 and the second cylinder 32, respectively. A first regenerator and a second regenerator (not shown) are incorporated into the first displacer and the second displacer, respectively. In addition, the room temperature portion 26 includes a drive mechanism 26a such as a motor for reciprocation of the first displacer and the second displacer. The drive mechanism 26a may include a flow path switching mechanism that switches between flow paths for a working gas (for example, helium) to periodically repeat supply and exhaust of the working gas into and from the cryocooler 14.

In addition, the cryopump 10 includes a radiation shield 36 and a cryopanel 38. In order to provide a cryogenic surface for protection of the cryopanel 38 from radiant heat from the outside of the cryopump 10 or the cryopump container 16, the radiation shield 36 is thermally coupled to the first cooling stage 30 and is cooled to the first cooling temperature.

The radiation shield 36 has, for example, a tubular shape, and is disposed to surround the cryopanel 38 and the second cooling stage 34. An end portion of the radiation shield 36 on the cryopump intake port 17 side is open so that a gas that enters the radiation shield 36 through the cryopump intake port 17 from the outside of the cryopump 10 can be received into the radiation shield 36. An end portion of the radiation shield 36 on an opposite side to the cryopump intake port 17 may be closed, may include an opening, or may be open. There is a gap between the radiation shield 36 and the cryopanel 38, and the radiation shield 36 is not in contact with the cryopanel 38. The radiation shield 36 is not in contact with the cryopump container 16 as well.

An inlet baffle 37 may be provided in the cryopump intake port 17 or between the cryopump intake port 17 and the cryopanel 38 to protect the cryopanel 38 from radiant heat from a heat source outside the cryopump 10 (for example, a heat source in the vacuum chamber 100 to which the cryopump 10 is attached). The inlet baffle 37 may be fixed to an open end of the radiation shield 36 to be thermally coupled to the first cooling stage 30 of the cryocooler 14 via the radiation shield 36. Alternatively, the inlet baffle 37 may be attached to the first cooling stage 30. The inlet baffle 37 is cooled to the same temperature as the radiation shield 36, and can condense a so-called type 1 gas (a gas that condenses at a relatively high temperature, such as vapor) on a surface thereof.

In order to provide a cryogenic surface that condenses a type 2 gas (for example, a gas that condenses at a relatively low temperature, such as argon and nitrogen), the cryopanel 38 is thermally coupled to the second cooling stage 34 and is cooled to the second cooling temperature. In addition, in order to adsorb a type 3 gas (for example, a non-condensable gas, such as hydrogen), for example, activated carbon or another adsorbent is disposed on at least a part of a surface (for example, a surface on the opposite side to the cryopump intake port 17) of the cryopanel 38. A gas that enters the radiation shield 36 from the outside of the cryopump 10 through the cryopump intake port 17 is captured through condensation or adsorption at the cryopanel 38. Since various known configurations can be adopted as appropriate as forms that can be taken, such as the disposition and shape of the radiation shield 36 or the cryopanel 38, description thereof will not be made in detail.

The cryopump container 16 includes a container body 16a and a cryocooler accommodating tube 16b. The cryopump container 16 is a vacuum chamber that is designed to maintain a vacuum during the evacuation operation of the cryopump 10 and to withstand a pressure in the ambient environment (for example, the atmospheric pressure). The container body 16a has a tubular shape of which one end includes the cryopump intake port 17 and the other end is closed. The radiation shield 36 is accommodated in the container body 16a, and the cryopanel 38 is accommodated in the radiation shield 36 together with the second cooling stage 34 as described above. One end of the cryocooler accommodating tube 16b is coupled to the container body 16a and the other end of the cryocooler accommodating tube 16b is fixed to the room temperature portion 26 of the cryocooler 14. The cryocooler 14 is inserted into the cryocooler accommodating tube 16b and the cryocooler accommodating tube 16b accommodates the first cylinder 28.

In the embodiment, the cryopump 10 is a so-called horizontal cryopump in which the cryocooler 14 is provided at a side portion of the container body 16a. A cryocooler insertion port is provided in the side portion of the container body 16a, and the cryocooler accommodating tube 16b is coupled to the side portion of the container body 16a at the cryocooler insertion port. Similarly, adjacent to the cryocooler insertion port of the container body 16a, a hole through which the cryocooler 14 passes is also provided in a side portion of the radiation shield 36. The second cylinder 32 and the second cooling stage 34 of the cryocooler 14 are inserted into the radiation shield 36 through the holes, and the radiation shield 36 is thermally coupled to the first cooling stage 30 around the hole in the side portion thereof.

The cryopump 10 can be installed in the vacuum chamber 100 in various postures at the site of use. For example, the cryopump 10 can be installed in a horizontal posture shown in the drawing, that is, a posture in which the cryopump intake port 17 faces an upper side. In this case, a bottom portion of the container body 16a is positioned below the cryopump intake port 17, and the cryocooler 14 extends in a horizontal direction.

The cryopump 10 includes a first temperature sensor 40 for measurement of the temperature of the first cooling stage 30 and a second temperature sensor 42 for measurement of the temperature of the second cooling stage 34. The first temperature sensor 40 may be attached to the first cooling stage 30. The second temperature sensor 42 may be attached to the second cooling stage 34. The temperature of the first cooling stage 30 measured by the first temperature sensor 40 can be regarded as the temperature of the radiation shield 36, and the temperature of the second cooling stage 34 measured by the second temperature sensor 42 can be regarded as the temperature of the cryopanel 38. Accordingly, the first temperature sensor 40 can measure the temperature of the radiation shield 36 and can output a first measured temperature signal indicating the measured temperature of the radiation shield 36. The second temperature sensor 42 can measure the temperature of the cryopanel 38 and can output a second measured temperature signal indicating the measured temperature of the cryopanel 38. In addition, a pressure sensor 44 is provided inside the cryopump container 16. The pressure sensor 44 is installed in, for example, the cryocooler accommodating tube 16b and can measure the internal pressure of the cryopump container 16 and output a measured pressure signal indicating the measured pressure.

In addition, the cryopump 10 includes a cryopump controller 46 that controls the cryopump 10. The cryopump controller 46 may be integrally provided with the cryopump 10. For example, the cryopump controller 46 may be attached to the room temperature portion 26. Alternatively, the cryopump controller 46 may be configured as a control device separated from the cryopump 10. Alternatively, one part of the cryopump controller 46 may be provided integrally with the cryopump 10 with the other part of the cryopump controller 46 provided separately from the cryopump 10, and the parts may be electrically connected to each other.

The cryopump controller 46 may control the cryocooler 14 based on the cooling temperature of the radiation shield 36 and/or the cryopanel 38 in the evacuation operation of the cryopump 10. The cryopump controller 46 may be connected to the first temperature sensor 40 to receive the first measured temperature signal from the first temperature sensor 40, and may be connected to the second temperature sensor 42 to receive the second measured temperature signal from the second temperature sensor 42.

In addition, the cryopump controller 46 can operate as a regeneration controller of the cryopump 10. In a regeneration operation of the cryopump 10, the cryopump controller 46 may control the cryocooler 14, the rough valve 18, the body purge valve 20, the exhaust valve 22, and the exhaust purge valve 24 based on the internal pressure of the cryopump container 16 (or if necessary, based on the temperature of the cryopanel 38 and the internal pressure of the cryopump container 16). The cryopump controller 46 may be connected to the pressure sensor 44 to receive the measured pressure signal from the pressure sensor 44.

The internal configuration of the controller is realized by an element or a circuit including a CPU and a memory of a computer as a hardware configuration and is realized by a computer program as a software configuration. However, in the drawing, the internal configuration is appropriately shown as functional blocks realized by cooperation of hardware and software. It is clear for those skilled in the art that such a functional block can be realized in various manners through combination between hardware and software.

For example, the controller can be implemented by a combination of a processor (hardware) such as a central processing unit (CPU) or a microcomputer and a software program executed by the processor (hardware). The software program may be a computer program for causing the controller to execute an evacuation operation and/or a regeneration operation of the cryopump 10.

The rough valve 18 is installed at the cryopump container 16 (for example, the cryocooler accommodating tube 16b). The rough valve 18 is connected to a rough pump (not shown) installed outside the cryopump 10. The rough pump is a vacuum pump provided to evacuate the cryopump 10 until an operation start pressure thereof is reached. The cryopump container 16 communicates with the rough pump when the rough valve 18 is opened by control performed by the cryopump controller 46. The cryopump container 16 is disconnected from the rough pump when the rough valve 18 is closed. It is possible to depressurize the cryopump 10 by opening the rough valve 18 and operating the rough pump.

The body purge valve 20 enables a “body purge” in which a purge gas is supplied to the container body 16a of the cryopump container 16. As an exemplary configuration, the body purge valve 20 is installed at the cryopump container 16 (for example, the container body 16a). In addition, the body purge valve 20 is connected to a purge gas source 48 or a purge gas supply device installed outside the cryopump 10.

A purge gas is supplied from the purge gas source 48 to the cryopump container 16 when the body purge valve 20 is opened by control performed by the cryopump controller 46, and the purge gas supplied to the cryopump container 16 is cut off when the body purge valve 20 is closed. It is possible to pressurize the cryopump 10 by opening the body purge valve 20 and introducing a purge gas into the cryopump container 16. In addition, the temperature of the cryopump 10 can be increased from the cryogenic temperature to the room temperature or a temperature higher than the room temperature. Alternatively, as described below, it is possible to supply a purge gas to the cryopump 10 while maintaining the pressure and the temperature in the cryopump 10 or suppressing a significant increase in pressure and the temperature in the cryopump 10 by adjusting the flow rate of the purge gas with the body purge valve 20.

The purge gas may be, for example, a nitrogen gas or another dry gas. The temperature of the purge gas may be adjusted to, for example, the room temperature (higher than 0° C., for example, 15° C. to 30° C.) or may be heated to a temperature (for example, 50° C. or lower or 80° C. or lower) higher than the room temperature. Alternatively, the temperature of the purge gas may be lowered to a temperature (for example, a temperature lower than 0° C.) lower than the room temperature. As described below, the cooling of the purge gas is suitable for suppressing an increase in temperature of the cryopanel 38 in a case where the purge gas is supplied to the cryopump container 16 during a cooling operation of the cryocooler 14.

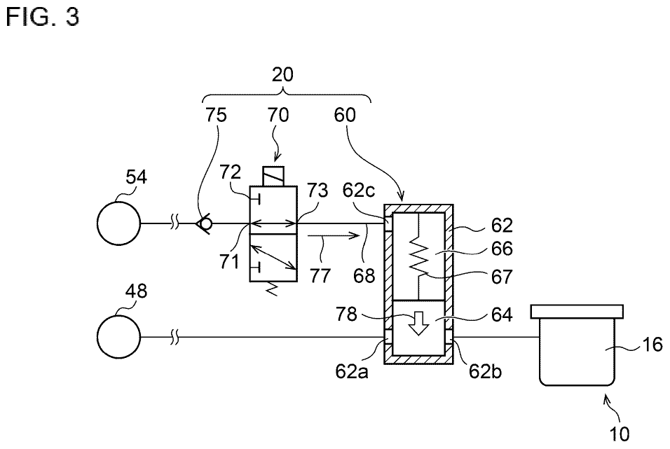

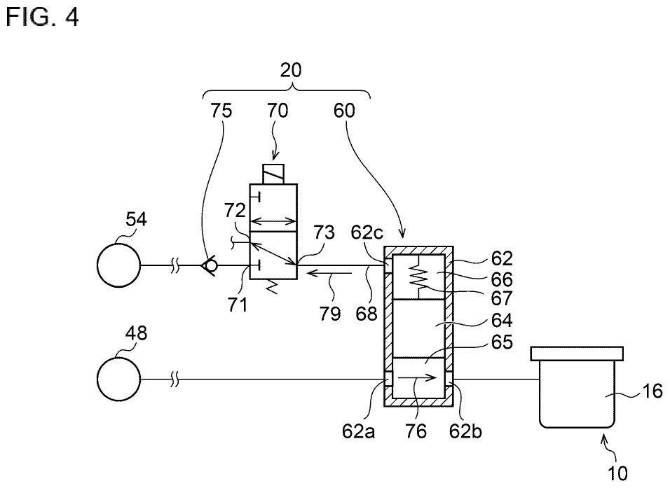

In the embodiment, as will be described later with reference to FIGS. 3 and 4, the body purge valve 20 may include a main valve 60 and a pilot valve 70.

The exhaust valve 22 is installed at the cryopump container 16 (for example, the cryocooler accommodating tube 16b). The exhaust valve 22 is provided as an outlet of the cryopump container 16 to exhaust a fluid from the inside of the cryopump 10 to the outside of the cryopump 10. The exhaust valve 22 also serves as an inlet to an exhaust line 50 described below. The fluid is exhausted from the cryopump container 16 when the exhaust valve 22 is opened by control performed by the cryopump controller 46 and the exhaustion of the fluid from the cryopump container 16 is stopped when the exhaust valve 22 is closed. Although the fluid to be exhausted from the exhaust valve 22 is basically a gas, the fluid may be liquid or a gas-liquid mixture. The exhaust valve 22 may be, for example, a normally-closed control valve.

In addition, the exhaust valve 22 may function as a vent valve or a safety valve or may be configured to be mechanically opened when a predetermined differential pressure acts thereon. In this case, the exhaust valve 22 is mechanically opened without requiring control when the internal pressure of the cryopump is made high for some reason. Accordingly, the high internal pressure can be released to the exhaust line 50.

The exhaust purge valve 24 enables an “exhaust purge” in which a purge gas is supplied to the exhaust line 50. As an exemplary configuration, the exhaust valve 22 and the exhaust purge valve 24 may be separately provided, and the exhaust purge valve 24 may be connected downstream of the exhaust valve 22 through a pipe. Alternatively, the exhaust purge valve 24 may be integrated with the exhaust valve 22 such that a purge gas is supplied to the exhaust valve 22 or a position downstream of the exhaust valve 22. The exhaust purge valve 24 may be installed at the cryopump container 16 (for example, the cryocooler accommodating tube 16b). The exhaust purge valve 24 is connected to the purge gas source 48 or another purge gas source.

A purge gas is supplied from the purge gas source 48 to the exhaust line 50 when the exhaust purge valve 24 is opened by control performed by the cryopump controller 46 and the purge gas supplied to the exhaust line 50 is cut off when the exhaust purge valve 24 is closed. Note that although the purge gas supplied from the exhaust purge valve 24 is generally the same type of gas (for example, a nitrogen gas) as a purge gas supplied from the body purge valve 20. However, a different type of suitable gas may also be used.

The exhaust line 50 is provided for exhaustion of an exhaust fluid from the cryopump 10 to a processing device 52, an upstream end of the exhaust line 50 is connected to the exhaust valve 22 and the exhaust purge valve 24, and a downstream end of the exhaust line 50 is connected to the processing device 52.

The processing device 52 may be, for example, an abatement device that processes a hazardous gas (for example, a hydrogen gas or another gas having explosiveness; or for example, a fluorine-based gas or another gas such as a halogen-based gas having corrosiveness or toxicity) in the exhaust fluid to produce a harmless gas, or may be a processing device that processes a hazardous gas to reduce hazardous properties. As the processing device 52, a well-known abatement device or processing device can be appropriately adopted. Therefore, the details thereof will not be described herein.

A gas is accumulated in the cryopump 10 as an evacuation operation of the cryopump 10 continues. In order to exhaust the accumulated gas to the outside, the regeneration of the cryopump 10 is performed. The regeneration of the cryopump 10 generally includes a temperature increase process, an exhaust process, and a cool-down process.

Agate valve 102 is installed between the cryopump 10 and the vacuum chamber 100 to be evacuated, and when the regeneration of the cryopump 10 starts, the gate valve 102 is closed and the cryopump 10 is disconnected from the vacuum chamber 100 (the internal volume of the cryopump 10 is isolated from the vacuum chamber 100).

The temperature increase process includes increasing the temperature of the cryopump 10 to a boiling point of a hazardous gas from among gases captured in the cryopump 10 or a temperature exceeding the boiling point and further increasing the temperature of the cryopump 10 to a regeneration temperature of the cryopump 10. Typically, the hazardous gas is, for example, a type 2 gas or a type 3 gas, and the boiling point of the hazardous gas is, for example, 100 K or lower. The regeneration temperature is, for example, the room temperature or a temperature higher than the room temperature. Accordingly, in many cases, the hazardous gas is revaporized in the first half of the temperature increase process (in particular, immediately after the start of the temperature increase process), is exhausted from the cryopump 10, and flows into the processing device 52. The hazardous gas is removed from the cryopump 10 in the temperature increase process.

A heat source for an increase in temperature is, for example, the cryocooler 14. The cryocooler 14 enables a temperature increase operation (so-called reverse temperature increase). That is, the cryocooler 14 is configured such that adiabatic compression of a working gas occurs when the drive mechanism 26a operates in a direction opposite to a direction in which the drive mechanism 26a operates in the case of a cooling operation (that is, the motor 26a driving the cryocooler 14 rotates reversely). With compression heat obtained in this manner, the cryocooler 14 heats the first cooling stage 30 and the second cooling stage 34. The radiation shield 36 and the cryopanel 38 are heated with the first cooling stage 30 and the second cooling stage 34 as heat sources, respectively. In addition, a purge gas supplied from the body purge valve 20 into the cryopump container 16 can also contribute to an increase in temperature of the cryopump 10. Alternatively, a heating device such as an electric heater may be provided in the cryopump 10. For example, an electric heater that can be controlled independently of the operation of the cryocooler 14 may be mounted on the first cooling stage 30 and/or the second cooling stage 34 of the cryocooler 14.

In the exhaust process, a gas captured in the cryopump 10 is revaporized or liquefied and is exhausted as a gas, liquid, or a gas-liquid mixture through the exhaust line 50 or through the rough valve 18. A type 2 gas and a type 3 gas can be easily exhausted from the cryopump 10 in the temperature increase process in an earlier stage. Therefore, the exhaust process is a process for exhaustion of a type 1 gas mainly. When the exhaust process is completed, the cool-down process is started. In the cool-down process, the cryopump 10 is cooled again to a cryogenic temperature for the evacuation operation. When the regeneration is completed, the gate valve 102 is opened again, and the cryopump 10 can start the evacuation operation again.

In a semiconductor manufacturing process, a hazardous gas having various hazardous properties such as explosiveness, corrosiveness, and toxicity may be used. When the temperature of the cryopump 10 is unintentionally increased due to some reason, the hazardous gas accumulated in the cryopump 10 may be revaporized, which results in an increase in concentration of the hazardous gas in the cryopump 10.

Such an unsafe state occurs, for example, due to a power failure or other abnormality. The cryopump 10 can perform an operation such as an evacuation operation or a regeneration operation under the control of the cryopump controller 46 as power is supplied from a main power source (not shown) such as a commercial power source. However, when a power failure of the main power source occurs, the operation of the cryopump 10 may be stopped. In a case where a power failure occurs, particularly in a case where it takes time to restore power after the power failure, the cryopump 10 may be heated by heat input from the ambient environment.

In order to solve the unsafe state, a so-called safety purge, in which the cryopump 10 is automatically purged, may be performed. In the safety purge, the body purge valve 20 is opened, and a purge gas is supplied from the purge gas source 48 to the cryopump container 16 through the body purge valve 20. A gas vaporized in the cryopump container 16 such as a hazardous gas is exhausted to the exhaust line 50 through the exhaust valve 22 together with the purge gas. In this manner, the concentration of the hazardous gas in the cryopump 10 can be lowered to a safe level.

One of the main purposes of use of the cryopump 10 is to evacuate an ion implanter. In this case, mainly a hydrogen gas is accumulated in the cryopump 10. Even when the hydrogen gas is revaporized in the cryopump 10, it is possible to exhaust the hydrogen gas from the cryopump 10 together with the purge gas by performing the safety purge at the time of a power failure. In this manner, the concentration of the hydrogen gas in the cryopump 10 can be reduced to a safe level (for example, to be lower than the explosion limit (about 4%) of the hydrogen gas).

The body purge valve 20 may be a normally-open valve. Accordingly, when power to the body purge valve 20 is lost, the body purge valve 20 returns to an open state which is a normal state thereof. In this manner, the body purge valve 20 can be automatically opened at the time of a power failure, and the safety purge can be reliably executed.

In the safety purge, the exhaust purge valve 24 may be opened so that a purge gas is supplied to the exhaust line 50. In this manner, the exhaust line 50 may be purged so that the concentration of a hazardous gas in the exhaust line 50 is quickly reduced to a safe level. For reliable execution of such a process, the exhaust purge valve 24 may be a normally-open valve.

In a case where the cryopump controller 46 is operable, the body purge valve 20 may be opened under the control of the cryopump controller 46 so that the safety purge is executed. In this case, the exhaust purge valve 24 may also be opened by the cryopump controller 46.

FIGS. 3 and 4 are diagrams schematically showing an exemplary configuration of the purge valve of the cryopump 10 according to the embodiment. As shown in the drawings, the body purge valve 20 includes the main valve 60 and the pilot valve 70. In addition, the body purge valve 20 may include a check valve 75 as described later.

The main valve 60 is configured such that the main valve 60 is closed to cut off a purge gas when a fluid is supplied from a fluid source 54 and the main valve 60 is opened for supply of the purge gas when the fluid is exhausted. The pilot valve 70 is configured to switch between a first state in which the fluid is supplied from the fluid source 54 to the main valve 60 and a second state in which the fluid is exhausted from the main valve 60. The first state is shown in FIG. 3, and the second state is shown in FIG. 4.

Therefore, when the pilot valve 70 is in the first state, the main valve 60 is closed so that a purge gas supplied to the cryopump container 16 is cut off. Meanwhile, when the pilot valve 70 is in the second state, the main valve 60 is opened so that the purge gas is supplied to the cryopump container 16. In FIG. 4, the flow of the purge gas is schematically represented by an arrow 76.

The main valve 60 may be a so-called air-operated valve. Therefore, a fluid that is supplied to and exhausted from the main valve 60 by the pilot valve 70 may be air (for example, compressed air). The fluid source 54 may be an air source (for example, a compressed air source).

The pilot valve 70 may be an external pilot type valve, and may be disposed outside the main valve 60 to be connected to the main valve 60. In this case, the pilot valve 70 may be disposed at a fixed position with respect to the main valve 60. For example, both of the main valve 60 and the pilot valve 70 may be attached to the cryopump container 16, or the main valve 60 and the pilot valve 70 may be connected to each other via a pipe 68 for fluid supply and exhaustion. Alternatively, the pilot valve 70 may be an internal pilot type valve, or may be incorporated into the main valve 60.

As an exemplary configuration, the main valve 60 includes a valve case 62 and a valve piston 64. The valve case 62 includes a purge gas inlet 62a, a purge gas outlet 62b, and a fluid port 62c. The purge gas inlet 62a is connected to the purge gas source 48, and the purge gas outlet 62b is connected to the cryopump container 16. The purge gas inlet 62a and the purge gas outlet 62b are opened and closed as the valve piston 64 moves as described later. The fluid port 62c is connected to the fluid source 54 through the pilot valve 70. The fluid port 62c is not opened and closed as the valve piston 64 moves. The fluid port 62c is always open.

The valve piston 64 is disposed to be reciprocatable in the valve case 62. The internal volume of the valve case 62 is divided into two chambers, which are a purge gas flow path 65 and a fluid chamber 66, by the valve piston 64. The purge gas flow path 65 includes the purge gas inlet 62a and the purge gas outlet 62b, and the fluid chamber 66 includes the fluid port 62c.

In addition, the valve piston 64 is connected to the valve case 62 by a return spring 67. The return spring 67 is provided to make the main valve 60 a normally-open valve. That is, the return spring 67 urges the valve piston 64 such that the purge gas flow path 65 is normally open.

The pilot valve 70 includes a supply port 71, an exhaust port 72, and a main valve port 73. The pilot valve 70 may be a three-way valve. The supply port 71 is connected to the fluid source 54. As shown in the drawings, the supply port 71 may be connected to the fluid source 54 via the check valve 75. The exhaust port 72 may be open to the ambient environment, or may be connected to a fluid collection tank (not shown). The main valve port 73 is connected to the fluid port 62c of the main valve 60 via the pipe 68.

In the first state of the pilot valve 70, as shown in FIG. 3, the supply port 71 and the main valve port 73 communicate with each other. In the first state, the exhaust port 72 is blocked. In addition, in the second state of the pilot valve 70, as shown in FIG. 4, the exhaust port 72 and the main valve port 73 communicate with each other. In the second state, the supply port 71 is blocked.

The pilot valve 70 may include a solenoid valve switching between the first state and the second state. In the embodiment, the pilot valve 70 is normally in the second state. That is, the pilot valve 70 is driven to enter the first state when power is supplied and returns to the second state when no power is supplied like when there is a power failure.

In a safe state where there is no abnormality such as a power failure (for example, in the evacuation operation of the cryopump 10), power is supplied to the pilot valve 70 and the pilot valve 70 enters the first state. As shown in FIG. 3, in the first state, the pilot valve 70 connects the fluid source 54 to the fluid chamber 66 of the main valve 60. As schematically represented by an arrow 77, a fluid is supplied from the fluid source 54 to the fluid chamber 66 through the pilot valve 70. The fluid pressure of the fluid chamber 66 is increased to be higher than the pressure of the purge gas flow path 65. Due to the fluid pressure of the fluid chamber 66, the valve piston 64 moves to decrease the volume of the purge gas flow path 65 and blocks the purge gas inlet 62a and the purge gas outlet 62b, as schematically represented by an arrow 78. The main valve 60 is closed, and a purge gas supplied from the purge gas source 48 to the cryopump container 16 is cut off. In this manner, the body purge valve 20 is closed as power is supplied. Since the body purge valve 20 is closed, the vacuum in the cryopump container 16 is maintained.

Meanwhile, in an unsafe state, the pilot valve 70 switches from the first state to the second state. For example, at the time of a power failure, no power is supplied to the pilot valve 70 and thus the pilot valve 70 returns to the second state from the first state. As shown in FIG. 4, in the second state, the pilot valve 70 connects the exhaust port 72 to the fluid chamber 66 of the main valve 60. The fluid source 54 is disconnected from the fluid chamber 66. As schematically represented by an arrow 79, a fluid is exhausted to the outside from the fluid chamber 66 through the pilot valve 70, and the fluid pressure of the fluid chamber 66 is lost. Due to a restoring force of the return spring 67, the valve piston 64 moves to increase the volume of the purge gas flow path 65 and the purge gas inlet 62a and the purge gas outlet 62b are connected to each other through the purge gas flow path 65. In this manner, the main valve 60, that is, the body purge valve 20 is opened, and as schematically represented by the arrow 76, a purge gas is supplied from the purge gas source 48 to the cryopump container 16. The body purge valve 20 can execute a safety purge.

The fluid source 54 is typically a cylinder storing a fluid. Since the residual pressure of the cylinder decreases due to consumption of the fluid, a user of the cryopump 10 needs to timely replace the used cylinder with a new cylinder. When the cylinder is continuously used in a state where the residual pressure of the cylinder is insufficient, the fluid source 54 cannot provide a fluid pressure for a switch to the first state of the pilot valve 70 to the fluid chamber 66 in the end. In addition, fluid supply to the pilot valve 70 is stopped also in a case where a pipe for fluid supply that is connected to the fluid source 54 is mistakenly removed.

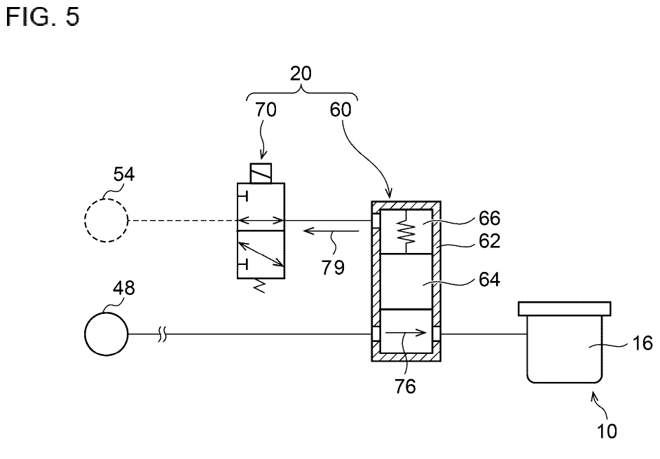

In a case where the fluid source 54 is directly connected to the pilot valve 70 (that is, in a case where the fluid source 54 is connected to the pilot valve 70 without the check valve 75 interposed therebetween) as shown in FIG. 5, the fluid pressure of the fluid chamber 66 is reduced or a fluid is exhausted from the fluid chamber 66 as schematically represented by the arrow 79 when fluid supply from the fluid source 54 to the pilot valve 70 is stopped. In this case, as if the pilot valve 70 has returned to the second state, the main valve 60 is opened and a purge gas is supplied to the cryopump container 16 as schematically represented by the arrow 76. When such an unintended safety purge occurs, a vacuum environment for a vacuum process is destroyed, and the process needs to be stopped. Since it takes a considerable amount of time and cost to deal with resumption of the process, the stoppage of the process is undesirable.

Therefore, the body purge valve 20 may be configured to restrict exhaustion of a fluid from the main valve 60 when fluid supply from the fluid source 54 is stopped with the pilot valve 70 being in the first state. In this case, exhaustion of a fluid from the main valve 60 is restricted when fluid supply from the fluid source 54 to the fluid chamber 66 is stopped due to a lack of pressure of the fluid source 54, unexpected removal of the pipe, or the like, so that the fluid pressure of the fluid chamber 66 can be maintained and the pilot valve 70 can remain in the first state continuously. Therefore, it is possible to prevent an unintended safety purge as described above. Meanwhile, in a situation where a safety purge is required, execution of the safety purge is not hindered. It is possible to execute the safety purge by causing the pilot valve 70 to switch from the first state to the second state so that a fluid is exhausted from the fluid chamber 66 and the main valve 60 is opened.

As an exemplary configuration provided to deal with an unintended safety purge, the check valve 75 may be used. As shown in the drawings, the check valve 75 is provided between the fluid source 54 and the supply port 71 of the pilot valve 70. The check valve 75 is connected between the fluid source 54 and the supply port 71 to allow a fluid to flow in a forward direction from the fluid source 54 to the supply port 71 and to prevent the fluid from flowing backward from the supply port 71 to the fluid source 54.

Since the check valve 75 allows a fluid to flow from the fluid source 54 to the supply port 71, supply of the fluid from the fluid source 54 to the main valve 60 through the pilot valve 70, which is performed in a state where the pilot valve 70 is in the first state, is not hindered.

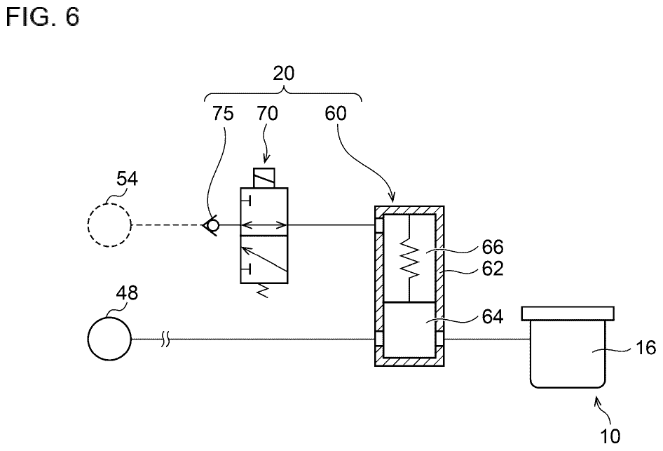

As shown in FIG. 6, when the supply of the fluid from the fluid source 54 to the fluid chamber 66 is stopped, the check valve 75 prevents the fluid from flowing backward from the supply port 71 to the fluid source 54, so that the fluid pressure of the fluid chamber 66 can be maintained and the pilot valve 70 can remain in the first state continuously. Therefore, it is possible to prevent an unintended safety purge as described above. Meanwhile, in a situation where a safety purge is required, execution of the safety purge is not hindered. In a situation where a safety purge is required, it is possible to execute the safety purge by causing the pilot valve 70 to switch from the first state to the second state so that a fluid is exhausted from the fluid chamber 66 and the main valve 60 is opened.

The check valve 75 may be disposed at a fixed position with respect to the pilot valve 70. For example, both of the pilot valve 70 and the check valve 75 may be attached to the cryopump container 16 to be connected to each other via a pipe for fluid supply and exhaustion. In this case, it is possible to prevent the pipe from falling off due to unexpected relative movement of the check valve 75 with respect to the pilot valve 70. Alternatively, the check valve 75 may be attached to the supply port 71 of the pilot valve 70.

In a case where a power failure is temporary (for example, in a case where the main power source restores power after the power failure before a temperature increase enough to cause revaporization of a gas occurs in the cryopump 10), a safety purge does not need to be executed. Therefore, the cryopump 10 have an uninterruptible power supply function that enables temporary power supply at the time of a power failure of the main power source. In this case, the cryopump 10 can continue to supply power to a purge valve and close the purge valve within the range of the power supply capacity of the uninterruptible power supply function even in the case of a power failure. The uninterruptible power supply function may be designed such that the purge valve is kept closed for at least 1 minute or at least 2 minutes. In addition, the uninterruptible power supply function may be designed such that the purge valve is kept closed for at most 10 minutes or at most 5 minutes.

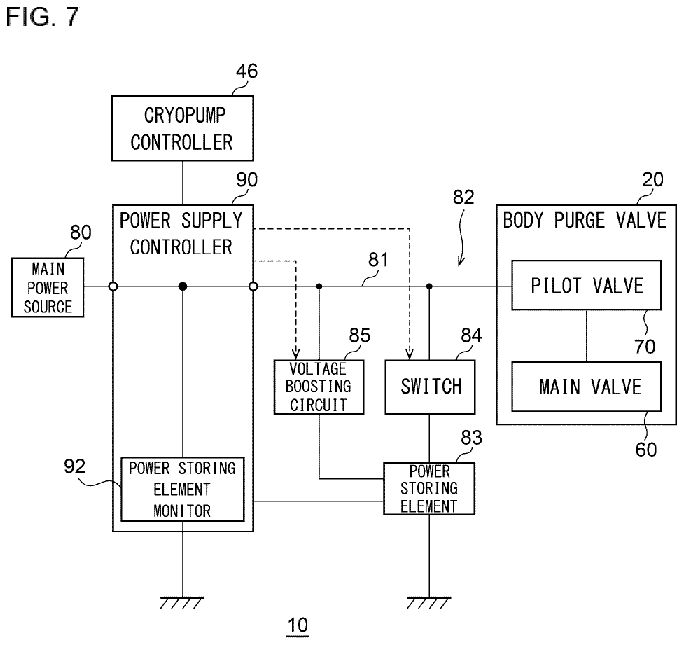

FIG. 7 is a diagram schematically showing a purge valve power source system of the cryopump 10 according to the embodiment. A purge valve (for example, the body purge valve 20) may include the main valve 60 and the pilot valve 70 as described above.

The pilot valve 70 may include the solenoid valve that is normally in the second state, as described above. When the pilot valve 70 is in the second state, the pilot valve 70 is driven to enter the first state when a drive voltage is supplied from the power source system to the pilot valve 70. In this manner, the pilot valve 70 switches from the second state to the first state. In a case where a supplied voltage from the power source system is higher than a return voltage when the pilot valve 70 is in the first state, the first state of the pilot valve 70 is maintained. The pilot valve 70 returns to the second state from the first state when the supplied voltage from the power source system decreases to a voltage equal to or lower than the return voltage.

The drive voltage is a rated voltage of the pilot valve 70, and may be, for example, a DC voltage of 12 V or 24 V. The return voltage of the pilot valve 70 is a voltage lower than the drive voltage. For example, the return voltage may be lower than half of the drive voltage.

As shown in the drawings, the power source system includes a main power source 80, a backup power source 82 that provides the uninterruptible power supply function, and a power supply controller 90 that controls both the power sources. The main power source 80 and the backup power source 82 are connected to the body purge valve 20 through a power supply line 81. The power supply controller 90 may be included in the cryopump controller 46.

The main power source 80 is configured to generate the drive power of the pilot valve 70 from an external power source such as a DC power source. When the main power source 80 is turned on, the power supply controller 90 is caused to operate by power supplied from the main power source 80 and controls power supply from the main power source 80 to the pilot valve 70. The power supply controller 90 may receive an instruction to close the body purge valve 20 from the cryopump controller 46 and cause a drive voltage to be supplied from the main power source 80 to the pilot valve 70 so that the pilot valve 70 switches to the first state from the second state and the body purge valve 20 is closed. In addition, the power supply controller 90 may receive an instruction to open the body purge valve 20 from the cryopump controller 46 and stop power supply from the main power source 80 to the pilot valve 70 so that the pilot valve 70 returns to the second state from the first state and the body purge valve 20 is opened.

The backup power source 82 is connected to the pilot valve 70 by the power supply line 81, and is configured to supply power to the pilot valve 70 instead of the main power source 80 at the time of a power failure of the main power source 80. The backup power source 82 may supply power to the pilot valve 70 under the control of the power supply controller 90 at the time of a power failure of the main power source 80. The backup power source 82 may be connected to the power supply controller 90 as well and may be configured to supply power to the power supply controller 90 instead of the main power source 80 at the time of a power failure of the main power source 80. The power supply controller 90 may be regarded as constituting a part of the backup power source 82.

The backup power source 82 includes a power storing element 83. For example, the power storing element 83 may be an electric double layer capacitor (also referred to as a supercapacitor). As shown in FIG. 7, the power storing element 83 may be connected to the power supply controller 90 to supply power to the power supply controller 90 instead of the main power source 80 at the time of a power failure of the main power source 80.

Note that in a case where the rated voltage of the power storing element 83 is lower than the return voltage of the pilot valve 70, the backup power source 82 may include a plurality of the power storing elements 83 connected in series, and the sum of the rated voltages of the plurality of power storing elements 83 may be higher than the return voltage of the pilot valve 70. Alternatively, the sum of the rated voltages of the plurality of the power storing elements 83 may be higher than the drive voltage of the pilot valve 70.

The backup power source 82 may include a switch 84 provided between the pilot valve 70 and the power storing element 83. The switch 84 may be connected between the power supply line 81 and the power storing element 83. The switch 84 may be controlled by the power supply controller 90. For example, the power supply controller 90 turns off the switch 84 to disconnect the power storing element 83 from the pilot valve 70 when the main power source 80 is turned on. In addition, the power supply controller 90 turns on the switch 84 to connect the power storing element 83 to the pilot valve 70 at the time of a power failure of the main power source 80.

Therefore, at the time of a power failure of the main power source 80, power can be supplied to the pilot valve 70 from the power storing element 83. In a case where the pilot valve 70 is in the first state at the time of occurrence of a power failure, the first state of the pilot valve 70 is maintained while a supplied voltage from the power storing element 83 to the pilot valve 70 is equal to or higher than the return voltage. When power stored in the power storing element 83 is consumed due to supply of power to the pilot valve 70 and the supplied voltage from the power storing element 83 to the pilot valve 70 is made lower than the return voltage, the pilot valve 70 returns to the second state from the first state.

In addition, the backup power source 82 may include a voltage boosting circuit 85 provided between the pilot valve 70 and the power storing element 83. The voltage boosting circuit 85 may be connected in parallel with the switch 84 between the power supply line 81 and the power storing element 83. The voltage boosting circuit 85 may be configured to generate a supplied voltage to the pilot valve 70 after boosting the output voltage of the power storing element 83 to be higher than the return voltage of the pilot valve 70. The voltage boosting circuit 85 may be, for example, a voltage boosting converter.

The voltage boosting circuit 85 may be a voltage boosting and dropping circuit, or may be, for example, a voltage boosting and dropping converter. In this case, the voltage boosting circuit 85 may supply the voltage to the power storing element 83 after dropping the voltage of the main power source 80 when the power storing element 83 is to be charged by the main power source 80.

The voltage boosting circuit 85 may be controlled by the power supply controller 90. For example, the power supply controller 90 may be configured to measure the output voltage of the power storing element 83 and to compare the output voltage of the power storing element 83 with a voltage threshold value. The voltage threshold value may be equal to the return voltage of the pilot valve 70. Alternatively, the voltage threshold value may be a voltage value higher than the return voltage, and may be, for example, a voltage value higher than the return voltage by 0.1 V to 1 V.

The power supply controller 90 may turn off the voltage boosting circuit 85 when the output voltage of the power storing element 83 is equal to or higher than the voltage threshold value. In this case, the output voltage of the power storing element 83 is supplied to the pilot valve 70 as it is. Since the supplied voltage from the power storing element 83 to the pilot valve 70 is equal to or higher than the return voltage, the first state of the pilot valve 70 is maintained.

Meanwhile, the power supply controller 90 may turn on the voltage boosting circuit 85 when the output voltage of the power storing element 83 is lower than the voltage threshold value. In this case, the output voltage of the power storing element 83 is supplied to the pilot valve 70 after being boosted to a voltage equal to or higher than the return voltage by the voltage boosting circuit 85. The first state of the pilot valve 70 is maintained until power stored in the power storing element 83 is consumed.

As another example, the voltage boosting circuit 85 may be connected in series with the switch 84 between the power supply line 81 and the power storing element 83. The voltage boosting circuit 85 may be configured to measure the output voltage of the power storing element 83 and to compare the output voltage of the power storing element 83 with the voltage threshold value. The voltage boosting circuit 85 may supply the output voltage of the power storing element 83 to the pilot valve 70 as it is when the output voltage of the power storing element 83 is equal to or higher than the voltage threshold value. Meanwhile, the voltage boosting circuit 85 may boost the output voltage of the power storing element 83 to a voltage equal to or higher than the return voltage and supply the output voltage to the pilot valve 70 when the output voltage of the power storing element 83 is lower than the voltage threshold value.

In this manner, the backup power source 82 can increase the length of a backup time, during which power can be supplied to the pilot valve 70, by using the voltage boosting circuit 85. Alternatively, a smaller power storing element 83 can be mounted in the backup power source 82 for realization of the same backup time, which is advantageous.

An increase in length of the backup time achieved by using the voltage boosting circuit 85 enables a decrease in charging rate of the power storing element 83. That is, the backup power source 82 can realize the same backup time with the power storing element 83 having a lower charging rate. When the power storing element 83 is repeatedly charged, the higher the charging rate is, the shorter the life of the power storing element 83 is. Therefore, a decrease in charging rate of the power storing element 83 contributes to an increase in life of the power storing element 83, which is advantageous.

In addition, as shown in FIG. 7, the backup power source 82 may be provided with a power storing element monitor 92. The power storing element monitor 92 may constitute a part of the power supply controller 90.

The power storing element monitor 92 may be configured to monitor the power storing element 83 by discharging the power storing element 83. The power storing element monitor 92 and the power storing element 83 may be connected to each other to form a discharge circuit that discharges the power storing element 83. The power storing element monitor 92 may be connected to the power storing element 83 via the power supply line 81. For example, the power storing element monitor 92 may include a constant current circuit that discharges the power storing element 83 at a constant current. The constant current circuit may be a known constant current circuit.

The power storing element monitor 92 may monitor a capacity C (F) of the power storing element 83. For example, in a case where the power storing element 83 is discharged by the constant current circuit through which a constant current I (A) flows, the capacity C (F) of the power storing element 83 is represented by the following equation.

C=I×T/ΔV

Here, ΔV (=V1−V2) represents a voltage difference between a discharge start voltage V1 (V) and a discharge end voltage V2 of the power storing element 83, and T (seconds) represents the discharge time of the power storing element 83 (that is, a time taken for the voltage of the power storing element 83 to decrease to the discharge end voltage V2 from the discharge start voltage V1 with the power storing element 83 discharged at the constant current I).

When power of the power storing element 83 is discharged to the constant current circuit of the power storing element monitor 92, the power storing element monitor 92 measures the constant current I, the voltage difference ΔV, and the discharge time T, and calculates the capacity C of the power storing element 83. In this manner, the power storing element monitor 92 can monitor the capacity C (F) of the power storing element 83.

The power storing element monitor 92 may compare the calculated capacity C with a capacity threshold value. In a case where the calculated capacity C is higher than the capacity threshold value, the power storing element monitor 92 may determine that the power storing element 83 is normal. The power storing element monitor 92 may output information indicating that the power storing element 83 is normal. Meanwhile, in a case where the calculated capacity C is equal to or lower than the capacity threshold value, the power storing element monitor 92 may determine that the power storing element 83 is abnormal. The power storing element monitor 92 may output information indicating that the power storing element 83 is abnormal (for example, information indicating that the capacity of the power storing element 83 has been decreased).

In this manner, the power storing element monitor 92 can monitor the power storing element 83 and detect an abnormality. For example, the power storing element monitor 92 can detect a decrease in capacity of the power storing element 83 caused by degradation over time or other causes.

The present invention has been described hereinbefore based on the examples. It will be understood by those skilled in the art that the present invention is not limited to the embodiment, various modification examples are possible, and such modification examples are also within the scope of the present invention. Various features described in relation to a certain embodiment are also applicable to other embodiments. New embodiments resulting from combinations have the effect of each of embodiments which are combined.

In the above-described embodiment, a case where the check valve 75 is used to cope with an unintended safety purge has been described as an example. However, other configurations can also be adopted. For example, a flow path resistor such as an orifice may be provided between the fluid source 54 and the supply port 71 instead of the check valve 75. In this case, the flow path resistor can restrict exhaustion of a fluid from the main valve 60 when fluid supply from the fluid source 54 is stopped with the pilot valve 70 being in the first state. A sudden decrease in fluid pressure of the fluid chamber 66 is suppressed, so that the pilot valve 70 can remain in the first state continuously for a while and an unintended safety purge can be delayed.

Alternatively, an on-off valve may be provided between the fluid source 54 and the supply port 71 instead of the check valve 75. In addition to the on-off valve, a pressure gauge that measures the pressure of the fluid chamber 66 may also be provided. In a case where the pressure measured by the pressure gauge is a pressure enough to maintain the first state of the pilot valve 70, the on-off valve may be closed manually or under the control of the cryopump controller 46. Even in this case, the on-off valve prevents a fluid from flowing backward from the supply port 71 to the fluid source 54 as with the check valve 75, so that the fluid pressure of the fluid chamber 66 can be maintained and the pilot valve 70 can remain in the first state continuously. The on-off valve may be opened manually or under the control of the cryopump controller 46 when the pilot valve 70 is in the second state. In this case, a fluid can be supplied again from the fluid source 54 to the fluid chamber 66 through the on-off valve when the pilot valve 70 switches to the first state from the second state.

In the above-described embodiment, a case where the body purge valve 20 includes the main valve 60 and the pilot valve 70 has been described as an example. However, a configuration in which not only the body purge valve 20 but also the exhaust purge valve 24 includes the main valve 60 and the pilot valve 70 or the exhaust purge valve 24 includes the main valve 60 and the pilot valve 70 instead of the body purge valve 20 may also be adopted. In the case, the exhaust purge valve 24 may be configured to restrict exhaustion of a fluid from the main valve 60 when fluid supply from the fluid source 54 is stopped with the pilot valve 70 being in the first state.

Although the present invention has been described using specific phrases based on the embodiment, the embodiment merely shows one aspect of the principles and applications of the present invention, and many modification examples and changes in disposition are allowed without departing from the scope of the present invention defined in the claims.

It should be understood that the invention is not limited to the above-described embodiment, but may be modified into various forms on the basis of the spirit of the invention. Additionally, the modifications are included in the scope of the invention.

What is claimed is:

1. A cryopump comprising:
a purge valve that comprises:
a main valve that is closed so that a purge gas is cut off as a fluid is supplied from a fluid source, and that is opened so that the purge gas is supplied as the fluid is exhausted, and
a pilot valve that switches between a first state in which the fluid is supplied from the fluid source to the main valve, and a second state in which the fluid is exhausted from the main valve,
wherein the purge valve is configured to restrict exhaustion of the fluid from the main valve when fluid supplied from the fluid source is stopped with the pilot valve being in the first state.

2. The cryopump according to claim 1,
wherein the pilot valve comprises a supply port that is connected to the fluid source and a main valve port that is connected to the main valve, the supply port and the main valve port communicating with each other in the first state, and
the purge valve comprises a check valve that is provided between the fluid source and the supply port and that prevents the fluid from flowing backward from the supply port to the fluid source.

3. The cryopump according to claim 1, further comprising:
a cryopump container that is connected to the main valve,
wherein the main valve is closed so that the purge gas supplied to the cryopump container is cut off when the pilot valve is in the first state, and is opened so that the purge gas is supplied to the cryopump container when the pilot valve is in the second state.

4. The cryopump according to claim 1, further comprising:
a backup power source that is connected to the pilot valve,
wherein the pilot valve comprises a solenoid valve that returns to the second state from the first state when a supplied voltage decreases to a voltage equal to or lower than a return voltage, and
the backup power source comprises:
a power storing element, and
a voltage boosting circuit that generates the supplied voltage to the solenoid valve after boosting an output voltage of the power storing element to be higher than the return voltage of the solenoid valve.

5. The cryopump according to claim 1, further comprising:
a backup power source that is connected to the pilot valve,
wherein the backup power source comprises:
a power storing element, and
a power storing element monitor that monitors the power storing element by discharging the power storing element.

6. A cryopump comprising:
a purge valve that comprises:
a main valve that is closed so that a purge gas is cut off as a fluid is supplied from a fluid source, and that is opened so that the purge gas is supplied as the fluid is exhausted, and
a pilot valve that switches between a first state in which the fluid is supplied from the fluid source to the main valve, and a second state in which the fluid is exhausted from the main valve; and
a backup power source that is connected to the pilot valve,
wherein the pilot valve comprises a solenoid valve that returns to the second state from the first state when a supplied voltage decreases to a voltage equal to or lower than a return voltage, and
the backup power source comprises:
a power storing element, and
a voltage boosting circuit that generates the supplied voltage to the solenoid valve after boosting an output voltage of the power storing element to be higher than the return voltage of the solenoid valve.

7. A cryopump comprising:
a purge valve that comprises:
a main valve that is closed so that a purge gas is cut off as a fluid is supplied from a fluid source, and that is opened so that the purge gas is supplied as the fluid is exhausted, and
a pilot valve that switches between a first state in which the fluid is supplied from the fluid source to the main valve, and a second state in which the fluid is exhausted from the main valve; and
a backup power source that is connected to the pilot valve,
wherein the backup power source comprises:
a power storing element, and
a power storing element monitor that monitors the power storing element by discharging the power storing element.
